(19) United States
(12) Patent Application Publication
(10) Pub. No.: US 2002/0123936 A1
(43) Pub. Date: Sep. 5, 2002

(54) Community partnership portals

(76) Inventors: Celeste K. Hansen, Prospect Heights, IL (US); Thomas A. Douglas, Lincolnshire, IL (US); John J. Ellwood III, Waterford, MI (US); Feng Guan, Glenview, IL (US); Barri Klingaman, Minneapolis, MN (US); John R. Larkin, Cockeysville, MD (US); Charles M. Schwartz, Trumbull, CT (US); Eric W. Smith, Rochester, NY (US); Sonney Taragin, Baltimore, MD (US)

Correspondence Address: NIXON & VANDERHYE P.C., 8th Floor, 1100 North Glebe Road, Arlington, VA, 22201, US

(21) Appl. No.: 09/796,742

(22) Filed: Mar. 2, 2001

(51) Int. Cl. G06F 17/60

(52) U.S. Cl. 705/26

(57) ABSTRACT

A community partnership portal enables a specific town's residents to shop stores in an on-line version of their town. Other links provide access to community related information. Using a map such as a graphical representation of the specific town, residents can “enter” a store by selecting the store's location on the map. The system enables town residents to benefit from local store familiarity with Internet convenience while supporting the economic health of a local community.

### BACKGROUND AND SUMMARY OF THE INVENTION

The present invention relates to a network of community partnership portals and, more particularly, to developing a community portal for a specific town over a computer network comprising an online virtual community corresponding to a physical community.

Internet use is expanding at a rapid rate, particularly with respect to commercial retail transactions over the Internet. Internet “stores” and “shopping areas” are somewhat impersonal, however, as consumers cannot benefit from store familiarity and salesperson recognition. Often, a consumer purchasing a product over the Internet is not even aware of the state from which the product is being purchased and/or shipped. This impersonal and unfamiliar nature of retail shopping over the Internet leads many consumers away from the Internet for these purposes.

According to the present invention, local communities and towns are provided with the opportunity to compete for business over the Internet while providing a venue of familiarity for community residents. A community portal enables local retailers to sell their goods and services in an on-line version of their local town. Retailers can “rent” Internet store front space in their on-line town. The virtual community is modeled after the actual city it services, displaying the participating retail stores in conjunction with, for example, a graphical representation of the town, such as a map. Customers, particularly community residents, are able to shop store offerings on the web, purchase or bid on items and receive delivery on the same or next day. For town residents who order through the site or become gift recipients, delivery occurs through local delivery services (such as through florist shops with delivery capability). Utilizing local delivery resources serves to fill unused capacity, increase the speed and immediacy of the sales transaction cycle, and maintain consumer familiarity using local stores. Other links enable community residents to access multitudes of community information.

According to an exemplary embodiment of the invention, a method of developing a community access portal for a specific town over a computer network includes (a) generating a home page with links to web pages that are relevant to the specific town, wherein one of the links is a map link to a map page that displays a map of the specific town; (b) providing town links from the map page to subscribing addresses in the specific town, wherein at least one of the town links is a retail store; (c) displaying products available from the retail store via the at least one of the town links; and (d) enabling a customer to complete a transaction with the retail store over the computer network. Step (a) may be practiced by generating a home page with links including a member link that enables a user to subscribe as a community member and create, update and edit a member profile. The member link may enable the member to shop retail stores of the specific town and/or to effect payment of town service bills and the like.

A retailer link can enable a retailer user to rent space as a retailer, update inventory, and list items for sale or auction. A community link enables the user to access community information, and a live feed link enables a user to access live video feeds from around the specific town via the computer network. Such live video feeds may include, for example, school classrooms, day care centers, sporting events, special events, town streets and town meetings. A restaurant link enables a user to access information about restaurants in a specific town and make reservations, and a hospital link enables a user to access hospital information and make video visits. Finally, an E-mail link enables users to E-mail other community member users.

Shopping may be practiced by accessing images of the retail store, such as images of an interior of the retail store, enabling the user to virtual shop the retail store. Alternatively or additionally, shopping may include accessing video clips of the goods and services.

In accordance with another exemplary embodiment of the invention, a computer system is provided for maintaining a community access portal for a specific town. A computer system includes at least one user computer running a computer program that requests information according to subscriber addresses in a specific town via a town map. A system server running a server program is connected with the at least one user computer by a computer network. The system server sends the requested information according to the subscriber addresses and enables a user via the user computer to virtual shop a retail store on the town map and complete a transaction over the computer network.

### BRIEF DESCRIPTION OF THE DRAWINGS

These and other aspects and advantages of the present invention will be described in detail with reference to the accompanying drawings, in which:

FIG. 1 is a schematic illustration of a network environment in conjunction with the present invention;

FIG. 2 is a schematic block diagram of the web site architecture according to the present invention; and

FIG. 3 is a schematic block diagram of a computer.

### DETAILED DESCRIPTION OF PREFERRED EMBODIMENTS

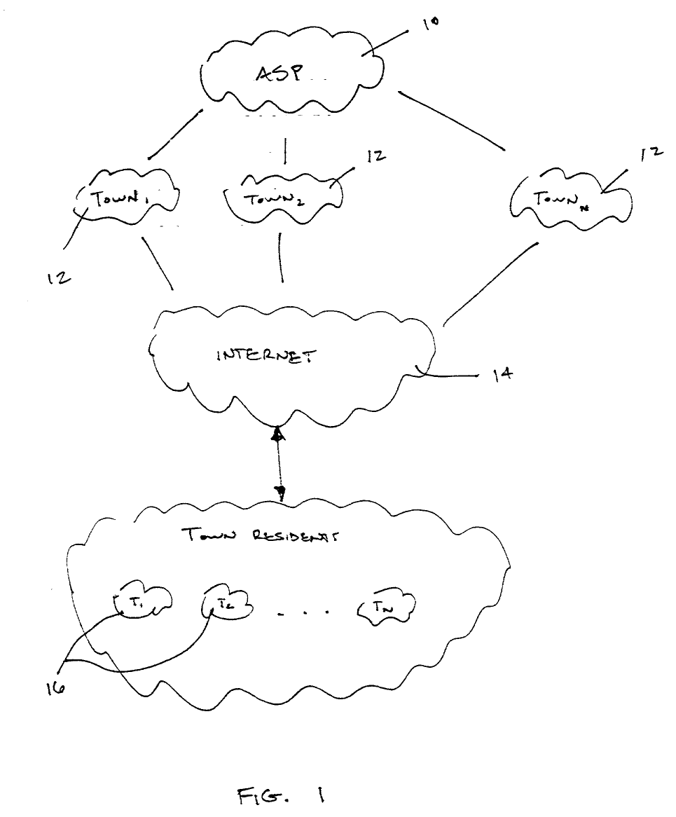

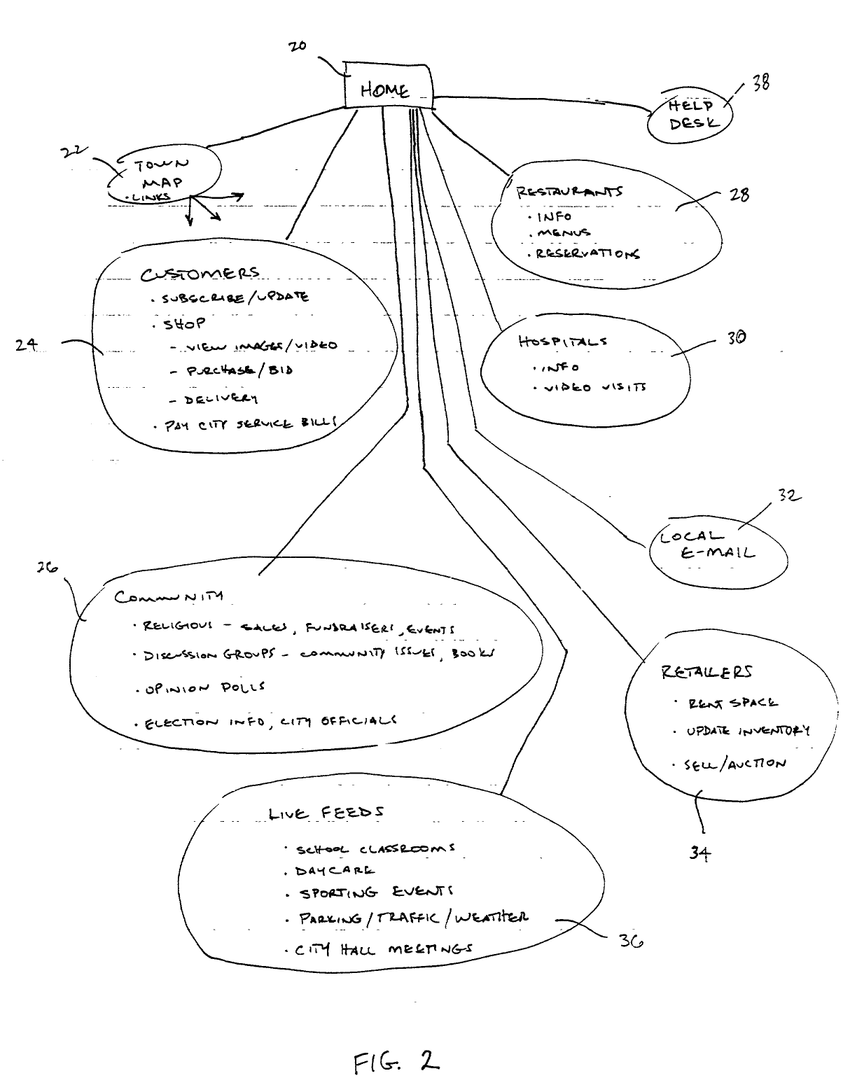

The community partnership portal system implemented in the diagrams of FIGS. 1 and 2 is preferably a browser-based system in which a program running on a user's computer (the user's web browser) requests information from a server program running on a system server. The system server sends the requested data back to the browser program, and the browser program then interprets and displays the data on the user's computer screen. The process is as follows:

1. The user runs a web browser program on his/her computer.

2. The user connects to the server computer (e.g., via the Internet). Connection to the server computer may be conditioned upon the correct entry of a password as is well known.

3. The user requests a page from the server computer. The user's browser sends a message to the server computer that includes the following:

the transfer protocol (e.g., http://); and

the address, or Uniform Resource Locator (URL).

4. The server computer receives the user's request and retrieves the requested page, which is composed, for example, in HTML (Hypertext Markup Language).

5. The server then transmits the requested page to the user's computer.

6. The user's browser program receives the HTML text and displays its interpretation of the requested page.

Thus, the browser program on the user's computer sends requests and receives the data needed to display the HTML page on the user's computer screen. This includes the HTML file itself plus any graphic, sound and/or video files mentioned in it. Once the data is retrieved, the browser formats the data and displays the data on the user's computer screen. Helper applications, plug-ins, and enhancements such as Java™ enable the browser, among other things, to play sound and/or display video inserted in the HTML file. The fonts installed on the user's computer and the display preferences in the browser used by the user determine how the text is formatted.

If the user has requested an action that requires running a program (e.g., a search), the server loads and runs the program. This process usually creates a custom HTML page “on the fly” that contains the results of the program's action (e.g., the search results), and then sends those results back to the browser.

Browser programs suitable for use in connection with the community portal system of the present invention include Netscape® Navigator available from Netscape® Communications Corporation and Internet Explorer available from Microsoft® Corp.

While the above description contemplates that each user has a computer running a web browser, it will be appreciated that more than one user could use a particular computer terminal or that a “kiosk” at a central location (e.g., a cafeteria, a break area, etc.) with access to the system server could be provided.

It will be recognized by those in the art that various tools are readily available to create web pages for accessing data stored on a server and that such tools may be used to develop and implement the community portal system described below and illustrated in the accompanying drawings.

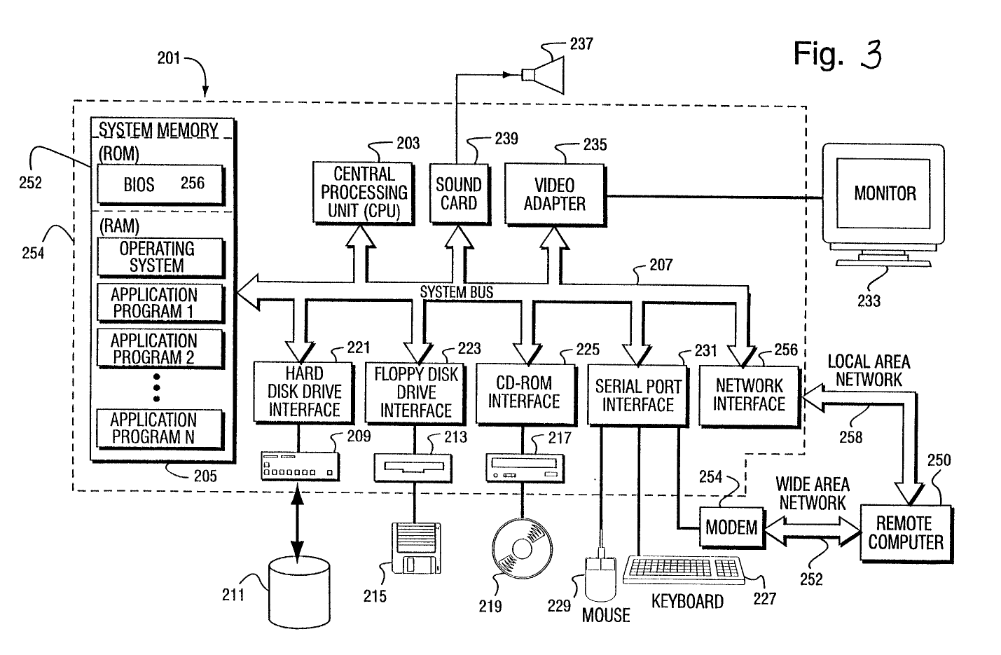

FIG. 3 generally illustrates a computer system 201 suitable for use as the client and server components of the community portal system. It will be appreciated that the client and server computers will run appropriate software and that the client and server computers may be somewhat differently configured with respect to the processing power of their respective processors and with respect to the amount of memory used. Computer system 201 includes a processing unit 203 and a system memory 205. A system bus 207 couples various system components including system memory 205 to processing unit 203. System bus 207 may be any of several types of bus structures including a memory bus or memory controller, a peripheral bus, and a local bus using any of a variety of bus architectures. System memory 205 includes read only memory (ROM) 252 and random access memory (RAM) 254. A basic input/output system (BIOS) 256, containing the basic routines that help to transfer information between elements within computer system 201, such as during start-up, is stored in ROM 252. Computer system 201 further includes various drives and associated computer-readable media. A hard disk drive 209 reads from and writes to a (typically fixed) magnetic hard disk 211; a magnetic disk drive 213 reads from and writes to a removable “floppy” or other magnetic disk 215; and an optical disk drive 217 reads from and, in some configurations, writes to a removable optical disk 219 such as a CD ROM or other optical media. Hard disk drive 209, magnetic disk drive 213, and optical disk drive 217 are connected to system bus 207 by a hard disk drive interface 221, a magnetic disk drive interface 223, and an optical drive interface 225, respectively. The drives and their associated computer-readable media provide nonvolatile storage of computer-readable instructions, SQL-based procedures, data structures, program modules, and other data for computer system 201. In other configurations, other types of computer-readable media that can store data that is accessible by a computer (e.g., magnetic cassettes, flash memory cards, digital video disks, Bernoulli cartridges, random access memories (RAMs), read only memories (ROMs) and the like) may also be used.

A number of program modules may be stored on the hard disk 211, removable magnetic disk 215, optical disk 219 and/or ROM 252 and/or RAM 254 of the system memory 205. Such program modules may include an operating system providing graphics and sound APIs, one or more application programs, other program modules, and program data. A user may enter commands and information into computer system 201 through input devices such as a keyboard 227 and a pointing device 229. Other input devices may include a microphone, joystick, game controller, satellite dish, scanner, or the like. These and other input devices are often connected to the processing unit 203 through a serial port interface 231 that is coupled to the system bus 207, but may be connected by other interfaces, such as a parallel port interface or a universal serial bus (USB). A monitor 233 or other type of display device is also connected to system bus 207 via an interface, such as a video adapter 235.

The computer system 201 may also include a modem 254 or other means for establishing communications over the wide area network 252, such as the Internet. The modem 254, which may be internal or external, is connected to the system bus 207 via the serial port interface 231. A network interface 256 may also be provided for allowing the computer system 201 to communicate with a remote computing device 250 via a local area network 258 (or such communication may be via the wide area network 252 or other communications path such as dial-up or other communications means). The computer system 201 will typically include other peripheral output devices, such as printers and other standard peripheral devices.

As will be understood by those familiar with web-based forms and screens, users may make menu selections by pointing-and-clicking using a mouse, trackball or other pointing device, or by using the TAB and ENTER keys on a keyboard. For example, menu selections may be highlighted by positioning the cursor on the selections using a mouse or by using the TAB key. The mouse may be left-clicked to select the selection or the ENTER key may be pressed. Other selection mechanisms including voice-recognition systems, touch-sensitive screens, etc. may be used, and the invention is not limited in this respect.

FIG. 1 is a network environment illustrating the principles according to the present invention. For developing a community partnership portal, an application service provider (ASP) 10 seeks towns 12 having particular demographic characteristics. These characteristics may include, for example, household income, home values, population, retail sales and the like. As will be apparent to those of ordinary skill in the art, the demographic characteristics for selecting towns and communities suitable for the community partnership portal of the present invention can be widely varied, and the invention is not meant to be limited to the described examples.

After discriminating suitable towns and/or communities according to determined demographic characteristics, the ASP 10 develops and maintains via the Internet 14 or other computer network an on-line version 16 of each town for access by community members. Preferably, each “on-line town” is separate and distinct from other ASP-created on-line towns and is only accessible by community residents or otherwise qualified subscribers. Since certain towns and communities may have a national appeal, it is desirable to enable global access to certain on-line towns (e.g., Beverly Hills, Calif.). In this context, non-residents may become qualified subscribers by paying a fee or the like. Additionally, certain links/features may require subscription and/or payment of a fee for access such as live feeds discussed below.

Referring to FIG. 2, a completed on-line town preferably includes a home page 20 with a plurality of links to town-related information. At least one of the links is a map link 22 that requests and displays a map corresponding to the respective town. In the context of the present invention, the term “map” is meant to encompass a conventional graphical illustration, showing streets, store locations and possibly even vegetation or other cartoon-like representations; and also non-conventional map configurations such as a site index, alphabetical listing, listing by address or the like. It is preferred, however, that the map utilize a graphical representation of the town to provide a more user-friendly entertaining display and to give a local and more familiar feel to the user.

The displayed map of the specific town preferably includes selectable links to various town businesses that are subscribers of the community partnership portal. In the preferred example, the user selects a particular location by clicking a link at the graphical location on the map. By making such a selection, the system may provide the user with a display of the store entrance as well as its address and phone number and other store information (such as hours, proprietor, etc.). Assuming the selected location is a retail store, for example, the user can “virtual shop” by requesting images of store aisles or products. Alternatively, the site may list specific products for sale or auction along with an image or video and appropriate product information.

Users may thus purchase products from local stores via their community partnership portal. In this context, the server system runs suitable program software to effect completion of the transaction including product selection, “shopping cart” maintenance, bid processing (in the case of an auction), payment processing and the like, all of which are known and do not form part of the present invention. Further details of the transaction completion software will thus not be further described. When the transaction is completed, the user is provided an opportunity to effect delivery of the purchased products using local delivery services. In this context, credit card use over the Internet may not be necessary since payment can be processed at the time of delivery.

With continued reference to FIG. 2, from the home page 20 or directly from the map page 22 discussed above, users can access other town-related links via the community partnership portal.

Other links accessible from the home page include a customer link 24 where users can subscribe to different access levels (such as live feeds discussed below) or update a member profile. As is conventional, the member profile typically contains personal information including name, address, telephone number and possibly preferred payment methods including credit cards and the like, delivery preferences, etc. Customers may also access direct links to specific shops and additionally may pay city service bills such as water bills or the like via the customer link 24. A community link 26 may include information for local religious organizations such as sales, fundraisers, events and other community-related information plus discussion groups for community issues, books, etc., opinion polls, election information and information about city officials.

A restaurant link 28 provides information about local restaurants, including menus, and enables users to make reservations. A hospital link 30 can provide hospital information and incorporate a program to effect video “visits” of patients. A local E-mail link 32 enables residents to send E-mail messages to one another and may include a directory of residents and their E-mail addresses.

A retailer link 34 enables retailers to “rent” Internet store front space in their on-line town. Retailers can also update inventory and list items for sale or auction.

A live feed link 36 provides access to live streaming video of local events and daily activity. Digital cameras for this purpose are known, and the details thereof will not be further described. The live feed link 36 can enable parents to check in on day care centers and school classrooms. Homebound kids can also keep up with classroom activity and class work. Users may also view local sporting events, special events such as city hall meetings or the like, and current parking/traffic/weather situations via links to appropriately positioned town street cameras.

An on-line help desk 38 for navigation and general web site questions, delivery dispatch, etc. is also included and could be manned by local residents.

With the system according to the present invention, users can benefit from local business familiarity with Internet convenience. The system supports the growth and stability of the local business tax base while preventing the loss of local independent stores with zero burden on the existing infrastructure. For residents who subscribe to the community portal, it is a unique way to stay connected with their community in a variety of ways. Retailers have the opportunity to move unsold inventory, get incremental sales and gain market visibility through an Internet channel that expands their customer base. Small business owners and independent franchise owners gain a vastly expanded market presence. Plus, retailers can track customer buying behavior for future marketing. For smaller retailers, their own “.com” creates an e-commerce presence that previously seemed unattainable and provides a cost-effective weapon against malls and superstore drowning. For shoppers, the Internet becomes an increased choice for consumer goods and the opportunity to shop locally on the Internet, thereby supporting the economic health of a local community. For local resident shoppers, items can be received on the same or next day, without even using a credit card. Additionally, the opportunity to order gifts or the like on the Internet for a town resident from a local store that delivers is a very attractive option.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A method of developing a community access portal for a specific town over a computer network, the method comprising:
(a) generating a home page with links to web pages that are relevant to the specific town, wherein one of the links is a map link to a map page that displays a map of the specific town;
(b) providing town links from the map page to subscribing addresses in the specific town, wherein at least one of the town links is a retail store;
(c) displaying products available from the retail store via the at least one of the town links; and
(d) enabling a customer to complete a transaction with the retail store over the computer network.

2. A method according to claim 1, wherein step (a) is practiced by generating the home page with links including a member link that enables a user to subscribe as a community member and create, update and edit a member profile.

3. A method according to claim 2, wherein the member link further enables the member to shop retail stores of the specific town.

4. A method according to claim 2, wherein the member link further enables the member to effect payment of town service bills.

5. A method according to claim 1, wherein step (a) is practiced by generating the home page with links including a community link that enables a user to access community information.

6. A method according to claim 1, wherein step (a) is practiced by generating the home page with links including a live feed link that enables a user to access live video feeds from around the specific town via the computer network.

7. A method according to claim 6, wherein the live video feeds comprise at least one of school classrooms, daycare centers, sporting events, special events, town streets, and town meetings.

8. A method according to claim 1, wherein step (a) is practiced by generating the home page with links including a restaurant link that enables a user to access information about restaurants in the specific town and make reservations.

9. A method according to claim 1, wherein step (a) is practiced by generating the home page with links including a hospital link that enables a user to access hospital information and make video visits.

10. A method according to claim 1, wherein step (a) is practiced by generating the home page with links including an E-mail link that enables a user to E-mail other community member users.

11. A method according to claim 1, wherein step (a) is practiced by generating the home page with links including a retailer link that enables a user to rent space as a retailer, update inventory, and list items for sale or auction.

12. A method according to claim 1, wherein step (c) is practiced by accessing images of the retail store.

13. A method according to claim 12, wherein step (c) is further practiced by accessing images of an interior of the retail store, enabling the user to virtual shop the retail store.

14. A method according to claim 12, wherein step (c) is further practiced by accessing video clips of the goods and services.

15. A method according to claim 1, wherein step (d) is practiced by providing an option to effect local delivery of the purchased products.

16. A method according to claim 1, wherein step (d) is practiced by receiving payment for the purchased products over the computer network.

17. A web page developed according to the method of claim 1.

18. A web page according to claim 17, comprising:
a plurality of links to web pages that are relevant to the specific town, wherein one of the links is a map link to a map page that displays a map of the specific town;
a plurality of town links from the map page to subscribing addresses in the specific town, wherein at least one of the town links is a retail store;
means for displaying products available from the retail store via the at least one of the town links; and
means for enabling a customer to complete a transaction with the retail store over the computer network.

19. A computer system for maintaining a community access portal for a specific town, the computer system comprising:
at least one user computer running a computer program that requests information according to subscriber addresses in a specific town via a town map; and
a system server running a server program, the at least one user computer and the system server being interconnected by a computer network, the system server sending the requested information according to the subscriber addresses and enabling a user via the user computer to virtual shop a retail store on the town map and complete a transaction over the computer network.

20. A computer program embodied on a computer-readable medium for maintaining a community access portal for a specific town, the computer program comprising:
means for generating a home page with links to web pages that are relevant to the specific town, wherein one of the links is a map link to a map page that displays a map of the specific town;
means for providing town links from the map page to subscribing addresses in the specific town, wherein at least one of the town links is a retail store;
means for displaying products available from the retail store via the at least one of the town links; and
means for enabling a customer to complete a transaction with the retail store over the computer network.
